(19) United States
(12) Patent Application Publication
(10) Pub. No.: US 2005/0145651 A1
(43) Pub. Date: Jul. 7, 2005

(54) Powder source for a powder coating plant

(76) Inventors: Apostolos Katefidis, Gaertringen (DE); Jan Reichler, Konstanz (DE)

Correspondence Address: WILLIAM M HANLON, JR;YOUNG & BASILE, PC, 3001 WEST BIG BEAVER ROAD, SUITE 624, TROY, MI, 48084-3107, US

(21) Appl. No.: 10/971,834

(22) Filed: Oct. 22, 2004

(30) Foreign Application Priority Data
Oct. 23, 2003 (DE) 103 49 715.3

(51) Int. Cl. B67D 5/60; B67D 3/00; B67D 5/06

(52) U.S. Cl. 222/145.5

(57) ABSTRACT

A powder source for a powder coating plant comprises a storage vessel for powder and a star feeder metering unit, provided on its outlet. The outlet of the latter is connected to the inlet of a conditioning vessel, which has a permeable base section impinged by compressed gas and transfers metered powder and air to a fluid mixture, which is drawn off through an outlet at the lower end of the conditioning vessel.

### BACKGROUND OF THE INVENTION

The invention relates to a powder source for a powder coating plant.

Powder coating plants in particular serve to powder coat workpieces with paint powder, which after fusing and hardening forms a usually smooth and hard-wearing finish over the workpiece.

The particles of the powder to be applied are not fully hardened, so that after heating they can flow together into a continuous homogeneous paint film and after hardening form the smooth and hard paint film.

The not fully hardened powder particles milled from only part-hardened or dried material reach their softening point at temperatures in the region of 80° C. to 90° C. and then at higher temperatures gradually change into the fluid, liquid condition so that adjacent powder particles fuse into a continuous layer.

The not fully hardened powder particles, which in practice have a diameter of about 15 microns to about 40 microns, usually around 25 microns, are neither shear- nor temperature-stable, so that the powder particles can form clumps/agglomerates if compressed mechanically.

### SUMMARY OF THE INVENTION

A powder source for use in a powder coating plant is to be indicated by the invention, wherein a reliable and uniform supply of powder to powder coating stations is ensured without the risk of powder particles agglomerating.

With the powder source according to the invention good uniform metering of the powder conveyed from the storage vessel is achieved as a result of the star feeder metering equipment. This well-metered powder quantity is homogeneously distributed inside the downstream conditioning vessel in a fluidization gas and the fluid powder/gas mixture obtained in this way can be conveyed through lines to one or several powder coating stations.

A positive pressure is produced by the fluidization gas in the underneath region of the storage vessel, as a result of which uniform powder supply to an application unit can be depended on. In the case of several linked application units with differing internal resistance of the supply lines and application units (for example spraygun or bell disc) additional powder conveyance can be provided. This can exhibit an accelerator nozzle as described in the German Patent DE 100 53 295 A1 for example.

In the case of the inventive metering equipment compared to known powder conveyance systems the amount of air necessary for conveying the powder is also reduced. Hence it results that the powder mist is “gentler”. Thus the amount of over-spray can also be less.

Advantageous developments of the invention are indicated in sub-claims.

With the development of the invention, it is achieved in the individual cells of the star feeder that no angles are present, wherein powder particles would be exposed to wedge or clamp effects, which could lead to lasting settlement of small quantities of the powder taken up by a cell in each case. As a result the consistent accuracy of the powder supply would be impaired, on the one hand in the case of those cycles, during which some of the unitary amount corresponding to the cell volume is short-supplied, on the other hand whenever a quantity of settled powder breaks loose from a cell. With a star feeder no powder chamber has any surface sections in the inner area of the cell on which powder could settle.

The present invention indicates preferred geometries, wherein such caking/settlement of powder on the cell walls is prevented.

With a powder source also the transition point from powder storage vessel to the cells of the star feeder is smooth in each case, so that constant unobstructed gravity feed of powder from the storage vessel into the star feeder is ensured. Also no particle deposits can therefore build up at the transition points between delivery area and star feeder.

With the development of the invention, it is achieved that also no lasting settlement of powder on the walls of the cells in the star feeder takes place through adhesive forces of a physical, chemical or electrostatic nature, since a gentle gas current directed away from the cell wall counteracts such adhesive forces.

The development of the invention further indicates preferred possibilities as to how homogeneous fine air permeability can be realized for the cell walls.

With less sensitive powders settlement of the powder on the walls of the cells in the star feeder can also be prevented by means of one or several fine (0.2-035 mm) holes having a slightly conical discharge orifice and impinged by a gas current directed into the star feeder interior.

With a powder source, the repulsion of powder particles from the cell walls achieved by flow means can be controlled as a function of the angle of rotation of the star feeder or the position to the housing. On the inlet side the pressure impinging the backs of the star feeder walls is selected low, so as not to disturb the inward movement of the powder into the individual cells, which relies on the force of gravity. On the outlet side this impingement of pressure can be increased, in order to reliably remove all powder residues from the star feeder walls.

The angle-dependent different impingement of pressure onto the backs of the air-permeable star feeder walls can be achieved in a constructively very simple way.

With a powder source, it is ensured that also no powder particles lastingly settle on the walls of the star feeder accommodation area of the star feeder housing.

With a powder source, it is also ensured on the inlet side that there is a (gap) seal against the storage vessel.

With a powder source, it is further ensured that the powder is metered not only preferably at a single region of the conditioning vessel arranged under the metering equipment.

With the development of the invention, a further improved homogenization of the powder delivery into the conditioning vessel is achieved.

In order to improve filling of the individual chambers of the star feeder, without powder particles being able to cling on the sides directed towards the star feeder bearings, the open cross-section area at the lower end of the powder storage vessel is smaller than the cross-section area of the outer region of the star feeder accommodation areas.

Preferably, a trapezoidal orifice is provided on the lower side of the powder storage vessel, whereby the longer of the parallel base sides first brushes over the outer edge of the respective star feeder chamber in the main direction of rotation.

In a further embodiment, the outlet-side orifice of the powder storage vessel can also be round or oval.

In order to ensure complete emptying of the star feeder chamber, the cross-section area on the upper side of the conditioning vessel is the same or slightly larger than the outer cross-section area of the star feeder chamber, so that with continuous rotating motion of the star feeder the complete outer orifice of the star feeder chamber is open for a short time.

With a powder source the power supply and fluid supply are not required to use sliding contacts. Both can take place via sufficiently long cables and/or hoses.

Also the development of the invention is advantageous in regard to the prevention of powder caking on surfaces of the metering equipment.

With the development of the invention, it is achieved that the powder present in the storage vessel is already fluidized befoe the metering equipment. Such controlled uniform gravity feed of powder into the metering equipment and thus improved accuracy and consistent metering are achieved in this way.

There is provided a ventilation orifice in the storage vessel, through which fluidization gas is vented off. This fluidization gas flows against the direction of the incoming powder through the powder onto the surface of the powder volume present in the storage vessel and thus fluidizes the powder. The vented fluidization gas can be ducted into the ventilation shaft of the powder booth before a central filter unit without additional purification measures.

Fluidization is also continued in short bursts since it takes approx. 10 minutes until a homogeneous powder/air mixture is obtained.

With the development of the invention, it is achieved that no powder particles are carried out by the ventilation of the powder source.

With a powder source, it can be constantly determined how much powder is still present in the storage vessel and when the storage vessel for its part has to be refilled from transport containers. The weighing mechanism also serves to constantly control the powder quantity being supplied.

With a powder source, the powder present in a cell is also forcibly removed from the cell by an air jet pumped from outside.

With a powder source, small relative movements between the storage vessel and the conditioning vessel are possible; both containers however are connected to one another for sealed powder flow. Also thermal length variations can thus be absorbed, allowing slight position changes as they arise when the storage vessel is weighed, and also preventing vibration being transmitted from one vessel to the other. This is advantageous in regard to a homogeneous powder/gas mixture.

De-coupling of the system being weighed can also be ensured by having a flexible hose line, which leads to the application unit.

A filter provided in the upper section of the conditioning vessel ensures all-round homogenization of the powder present in the conditioning vessel. Furthermore any existing particle clumps are also retained.

As a result of the mesh width of a mesh filter being coordinated with the size of the powder particles, good homogenization of the powder flow over the cross section of the conditioning vessel is ensured without throughput being greatly reduced.

The development of the invention is advantageous in regard to an increase of throughput and in regard to the break up of any particle clumps found.

With the development of the invention good mixing of powder and fluidization gas is achieved in a substantially laminar flow within the conditioning vessel.

Also the development of the invention serves to create homogeneous mixing conditions for powder and fluidization gas.

At the lower end section of the conditioning vessel particularly homogeneous distribution of powder particles and fluidization gas is the case.

The powder outlet lies at the lowest point of the conditioning vessel so that the vessel can also be completely emptied. Thus it can be ensured when switching off the application unit that no powder remains in the supply line and thus no un-fluidized powder is drawn off when starting up again. In this case it should be considered that a time delay arises between metering and demand. This however is generally negligible, since normally the application unit is switched on before the surface to be coated arrives.

The conical shape of the fluid base linked with the possibility of completely emptying the vessel and hose system presents major advantages in the operation of the overall plant.

The geometric layouts are advantageous in regard to ensuring homogeneous and consistent fluidized powder delivery.

With the development of the invention, it is achieved that the mixture of powder and fluidization gas is conveyed, after having been accelerated and diluted, through lines to the coating stations. This is particularly advantageous with regard to several application units. In the case of one application unit (equipment such as spraygun etc.) the positive pressure in the conditioning vessel is normally sufficient to convey the powder.

Acceleration and dilution of the powder flow are achieved in a reliable way during constant operation without using moving parts.

### BRIEF DESCRIPTION OF THE DRAWINGS

The invention is described in detail below on the basis of embodiments with reference to the drawing; herein is shown:

FIG. 1: a block diagram of a powder coating plant

FIG. 2: a more detailed illustration of a powder source which is part of the powder coating plant shown in FIG. 1;

FIG. 3: an enlarged vertical section through a modified star feeder metering unit which can be used in the powder coating plant shown in FIG. 1 and/or the powder source shown in FIG. 2;

FIG. 4: an illustration of the overlapping by the powder outlet of the storage vessel and star feeder chamber in a first variant;

FIG. 5: an illustration of the overlapping by the powder outlet of the storage vessel and star feeder chamber in a second variant;

FIG. 6: a variant of FIG. 2;

FIG. 7: a further variant of FIG. 2; and

FIG. 8: a variant of FIG. 3.

### DETAILED DESCRIPTION OF THE PREFERRED EMBODIMENT

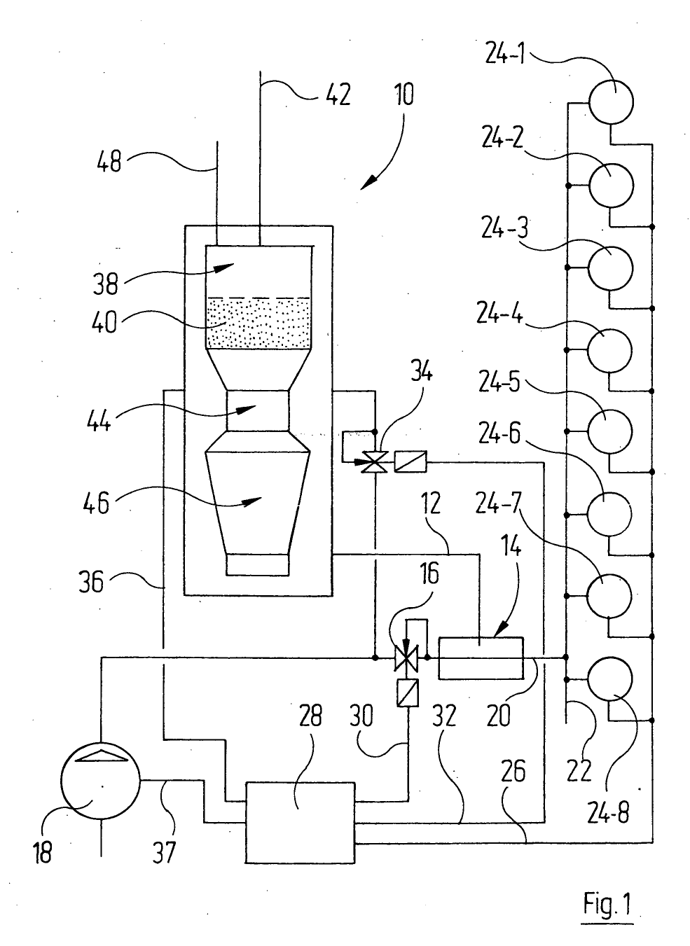

In FIG. 1 a powder source, which delivers a mixture of powder particles and a fluidization gas to a discharge line 12, is designated overall as 10. This mixture is fluid, similar to a liquid material and is fed to the inlet of an acceleration unit 14, which working according to the water jet principle accelerates and dilutes the powder flow.

This is preferably achieved by way of an annular nozzle, as described in the German Patent DE 10 53 295 A1. Other nozzle systems for compressed air are also conceivable, as for example, a central nozzle in a hose. It is only important that a flow directed to the application unit is provided so that the powder remains fluidized and no deposits form in the hoses.

For this purpose an acceleration air input of the accelerator unit 14 is connected via a pressure control valve 16 to the output of a compressor 18 in the case of the embodiment observed here.

A discharge line 20 of the acceleration unit 14 is connected to a distributor line 22, which in turn is connected to inlets of a plurality of powder application stations 24-1, 24-2 to 24-8. These are designated in the following, unless distinction is important, simply as powder application stations 24.

The powder application stations 24 are connected via a control cable 26 to a control unit 28.

The latter regulates a solenoid of the pressure control valve 16 via a further control cable 30, in order to adjust its control pressure.

Via a further control cable 32 the control unit 28 regulates a solenoid of a further pressure control valve 34, as the result of which an inlet for fluidization gas of the powder source 10 is connected to the output of the compressor 18.

Finally via a control cable 36 the control unit 28 regulates further loads contained in the powder source 10 and via this cable receives sensor output signals from the power source 10, as will be described more exactly later. The compressor 18 is regulated via a control cable 37.

In this way the speed and concentration of the powder particles, which are supplied to the various powder application stations, can be regulated and furthermore whether the powder application stations 24 operate or otherwise can be controlled.

The powder source 10 has three main components. First a storage vessel 38, which contains a volume 40 of powder to be applied, as indicated schematically in FIG. 1. In order to refill the powder volume 40 at intervals, the upper end of the storage vessel 38 is connected to a feeder line 48, which is supplied with powder from transport containers.

The second main component of the powder source 10 is a metering unit 44, which works according to the star feeder principle. It is arranged at the lower end of the storage vessel 38 and allows an exactly pre-defined amount of powder to flow from the storage vessel 38 into a conditioning vessel 46 (third main component) arranged thereunder, as described more exactly below. The conditioning vessel 46 mixes the metered powder with a fluidization gas and the mixture of powder particles and fluidization gas obtained in this way is delivered to the discharge line 12, which has already been mentioned above.

As far as fluidization gas is not ducted via the discharge line 12, it can be fed via a ventilation line 48, which is connected to the upper end of the storage vessel 38.

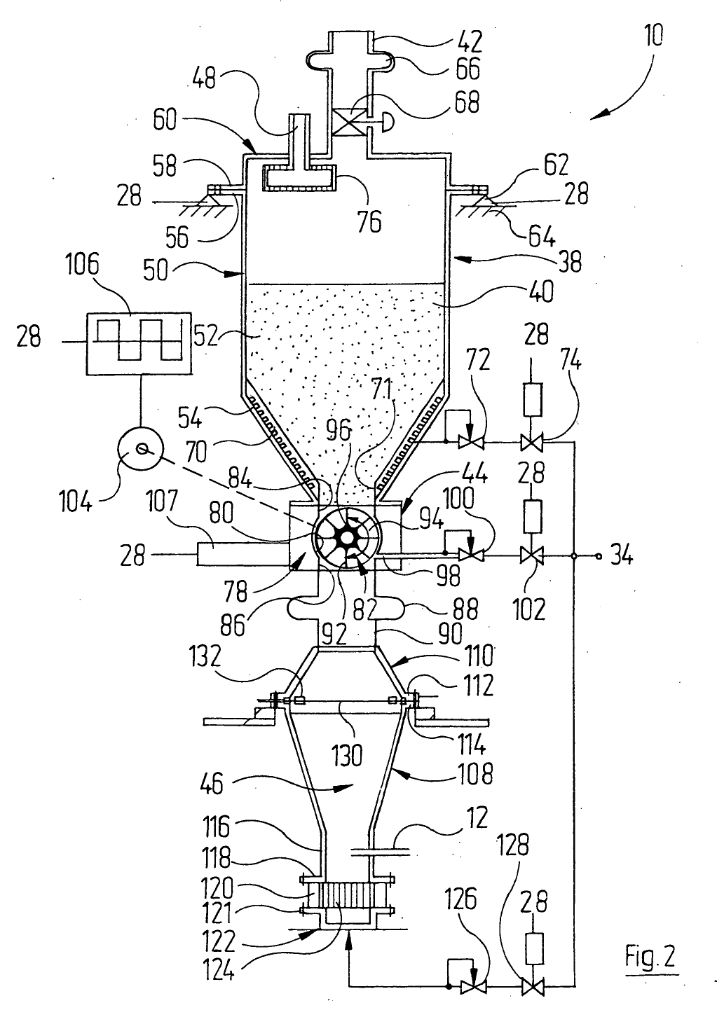

Details of the powder source 10 are now described with reference to FIG. 2, whereby connections to external parts of the powder coating plant are indicated by way of the same reference symbols.

As evident from FIG. 2 the storage vessel 38 has a lower housing part 50 with a cylindrical peripheral wall 52 and a lower truncated peripheral wall 54, which is seated on the lower edge of the peripheral wall 52.

The top edge of the peripheral wall 52 supports a horizontal flange 58, which is bolted to a suitable horizontal flange 58 of a cover 60.

The storage vessel 38 is supported with the flange 58 suspended via weighing cells 62 on static frame sections 64. The weighing cells 62 provide electrical signals characterizing the momentary weight of storage vessel 38 and actual powder volume 40, which are fed to inputs of the control unit 28.

The feeder line 42 contains a compensator 66 and it can be closed in the vicinity of the cover 60 by a supply valve 68, which is constituted as pinch valve or piston valve.

Inside a porous conical wall material 70 made of open-pored sinter material is laid over the conical lower peripheral wall 54 of the storage vessel 38, whose lower end bounds an outlet 71 and whose back is connected to the output of the pressure control valve 34 via a pressure control valve 72 and a solenoid valve 74, which is operated by the control unit 28.

When the open solenoid valve 74 is open, air flows constantly through the porous wall material 70 into the powder volume 40 and prevents the powder particles interlinking with one another and bonding together. In this way the powder, which is in the storage vessel 38, remains viscous.

The ventilation line 48, whose end leading into the storage vessel 38 is closed by a filter head 76, which is disc-shaped and on its two end faces supports a filter material, that retains powder particles, is also recognized on the cover 60.

The star feeder metering unit 44 has a star feeder housing 78, in which a cylindrical accommodation area 80 is provided for a corresponding cylindrical star feeder 82. The star feeder housing 78 has an inlet 84, which communicates with the lower open end of the storage vessel 38 as well as an outlet 86 lying underneath, that is connected to the inside of the conditioning vessel 46 via a line 90 containing a compensator 88.

As evident from the drawing the star feeder 82 has cell walls 92 arranged in a star shape, which bound cells 94 lying in-between. Bases 96 of the cells 92 are cylindrically formed, smoothly merging without curves into the side areas of the cell walls 92.

A housing duct 98 of the star feeder housing 78, which perpendicularly to the projection plane of FIG. 2 has the same dimension as the star feeder 82, opens out at the intersection point between outlet 86 and accommodation area 80 and is connected via a further pressure control valve 100 and a solenoid valve 102 to the outlet of the pressure control valve 34. The solenoid valve 102 is again operated by the control unit 28.

The star feeder 82 is driven by an electric motor 104. This is controlled by a gate circuit 106 alternately in forwards and backwards direction at equal time intervals. In this way it is achieved that the powder, which in the cells of the star feeder 82 is taken from the storage vessel 38 into the conditioning vessel 46, does not fall on one side into the conditioning vessel 38.

Alternately the electric motor 104 can be a step-up motor and the gate circuit 106 can be formed so that it controls the step-up motor in forwards and/or backwards direction respectively by a plurality of steps corresponding to revolutions.

The gate circuit 106 for its part is governed by the control unit 28.

A vibrator or a breaker 107 is attached to the star feeder housing 78 in order to vibrate the entire housing, the star feeder 82 accommodated therein and the lower end of the storage vessel 38. Preferably the vibrator or breaker 107 is excited by the control unit 28 at a frequency in the order of magnitude of 60 Hz. The exciter 107 can be a magnetostrictive, pneumatic or also an electromechanical vibrator.

The conditioning vessel 46 in turn again consists of a lower vessel section 108 as well as an upper vessel section 110. These have flanges 112 and/or 114 on the edges adjacent to one another, on which they are bolted together.

The upper vessel section 120 extends from the delivery end of the line 90 truncated downwards, while the lower vessel part 168 starting from the upper vessel section 110 tapers conically downward and then has a cylindrical vessel section 116. The latter at its lower end has a horizontal flange 118, which is bolted via an annular section 120 to a lower cup-shaped cover 122.

A disc-shaped gas-permeable base section 124 is arranged lying inside the annular section 122. The base back area bound by its lower surface and the cover 122 is connected via a pressure control valve 126 and a solenoid valve 128 to the outlet of the pressure control valve 34.

A mesh filter 130 is clamped between the two housing parts 108, with ultrasonic generators 132 connected in-between. The mesh filter 130 is woven from stainless steel wire. For use with powder coatings, which contain powder particles with an average size of approximately 25 microns the diameter of the stainless steel wire is 40 microns and the mesh size of the filter is 125 microns.

The ultrasonic generators 132 are excited by the control unit 28 at a frequency of about 20 kHz.

The mesh filter 130 thus extends perpendicularly to the axis of the conditioning vessel 46 evenly and tautly through an upper section of the conditioning vessel, at the same time executing a high frequency movement of low amplitude. In this way powder, falling on the top of the mesh filter 130, is harmonized in directions perpendicular to the axis of the conditioning vessel 46, as a result of which any particle clumps contained in the incoming powder are broken up.

The harmonized powder curtain obtained behind the mesh filter 130 falls downwards under the force of gravity and as a result is mixed intimately and uniformly with the air current directed from the base section 124 in a laminar flow perpendicularly upwards.

Thus a homogeneous mixture of powder particles and fluidization gas constituted by air is obtained in the cylindrical vessel section 116.

The discharge line 12 is led in the centre of the vessel section 116 and to be precise approximately at ⅔ the height of the cylindrical vessel section 16.

If the distance between the mesh filter 130 and the top of the base section 124 is D and if the distance of the discharge line 12 from the top of the base section 124 is d, the ratio d:D is between about 1:8 and about 1:4, preferably about 1:6.

The powder source 10 described in detail above with reference to FIG. 2 works as follows:

The powder volume 40 present in the storage vessel 38 is separated with air passing through the porous wall material 70 and kept in a viscous state. The star feeder 82 continuously removes powder quantities corresponding to the volume of the cells from the aerated powder, which on reaching the outlet 86 fall downwards from the cells and through the line 90 onto the top of the mesh filter 130.

The air supplied via the housing duct 58 assists in removing powder from the cells of the star feeder 82.

The mesh filter 130 is impinged by powder material symmetrically to the vessel central plane since the star feeder 82 is driven by the electric motor 104 through the signals emitted by the gate circuit 106 at equal time intervals in forwards and backwards direction.

As a result of the filter effect and also the ultrasonic impingement the powder material is again harmonized in the transversal direction, and a substantially homogeneous powder curtain, which falls downwards and thereby meets the air current directed upwards, that is pumped through the base section 124, is obtained underneath the mesh filter 130.

At the place of the cylindrical vessel section 116 mentioned above a homogeneous mixture of powder and fluidization gas is drawn off through the discharge line 12.

If overall more compressed air is fed to the powder source 10 via the pressure regulator 72, 100 and 126 than fluidization air is drawn off together with powder via the discharge line 12, any residual air is vented off via the filter head 76 and the ventilation line 48.

It is clear that programmable pressure control valves can also be used similarly as described with reference to the pressure control valves 16 and 34 of FIG. 1, in modification of the embodiment as described above according to FIG. 2 for the different impingement of the pressures connected to the pressure relief valves 72, 100 and 126.

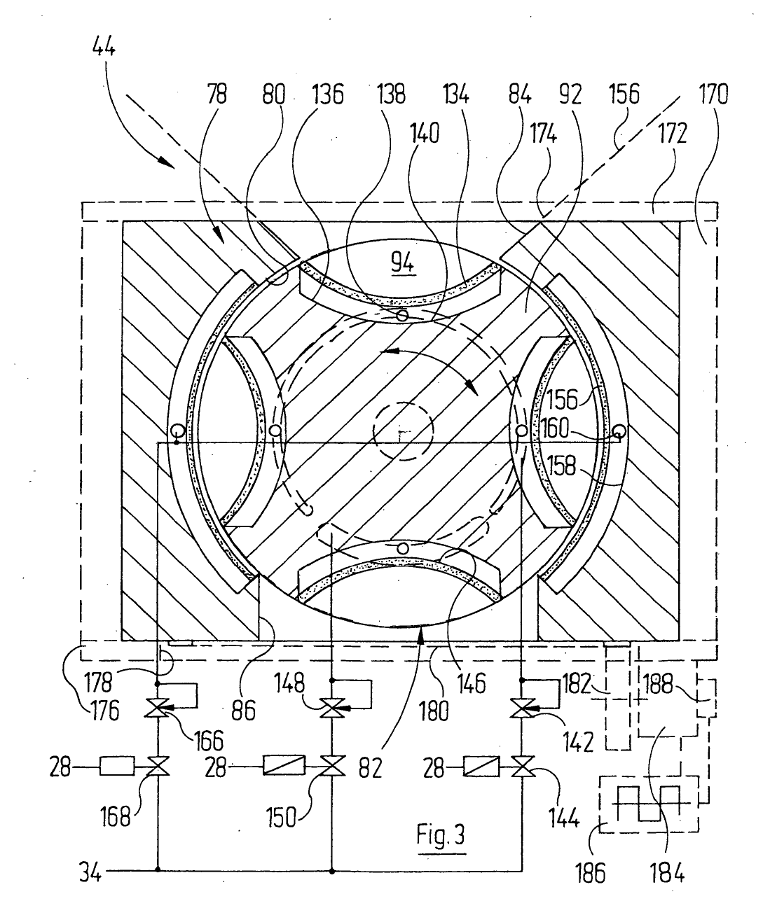

In FIG. 3 components of the star feeder metering unit 44, which have already been described above with reference to FIGS. 1 and 2, are again provided with the same reference symbols as far as they fulfill the same function and even if they differ in detail constructionally.

Only the differences from the star feeder metering unit 44 already described are indicated below.

The cells 94 of the star feeder 92 in each case have the form of ball sections (domes) and are bound by a base wall 134, which is made of porous gas-permeable material. Behind the base walls 134 in each case lies an air chamber 136, which communicates with an axis-parallel supply duct 138. The latter is axially continued to the front face of the star feeder 92 in FIG. 3 to be imagined behind the projection plane.

A first supply groove 140, which extends over an angle of approximately 280° is provided radially flush with the line of the ends of the supply ducts 138. The supply groove 140 is connected via a pressure control valve 142 and a solenoid valve 144 to the output of the compressor 34.

The pressure control valve 142 is adjusted in such a way that a small air current flows through the base walls 134, preventing the powder particles settling on the exterior surface of the base walls 134, which however is not sufficient to blow the powder particles away.

A second supply groove 146 extends at the outlet 86 of the star feeder housing 78 over an angle of approximately 60°. This groove is drawn with a somewhat larger radial dimension, in order to indicate that it is impinged via a further pressure control valve 148 and a solenoid valve 150 by greater pressure than the supply groove 140. When positioned near the outlet 66 it generates an air current through the base wall 134, as a result of which the residual powder volume remaining in front of the base wall 134, that has not already fallen off by the force of gravity, is forcibly blown away.

As evident from the drawing the curvature of the base walls 134 is selected so that the radially outer lying side of the base walls 134 in each case represents a smooth steady continuation of the inlet 84 constituted as conical inlet slope, whenever a base wall 134 stands on the inlet side along the vertical axis of inlet and outlet of the star feeder housing 78. The inlet 84 for its part represents an extension of a funnel-shaped lower end section of the storage vessel 38, which is shown in FIG. 3 with 156 only as broken line.

It is recognized that the supply grooves 140 and 146 are formed symmetrically to the vertical central plane of the star feeder metering unit 44, so that the star feeder 82 again can be equally used in both directions of rotation, as described above.

If the star feeder is to be used in only one direction of rotation, the supply groove 140 can also be limited to that peripheral angle, in which powder material lies on the base wall 134.

In order to prevent the powder material falling out prematurely from the gap between accommodation area 80 and star feeder 82, the accommodation area 80 can be provided in the case of the exemplary embodiment respectively over an angle of approximately 80° with a gas-permeable wall 156, behind which an air chamber 158 lies. This is again connected via a supply duct 160, a pressure control valve 166 as well as a solenoid valve 168 to the output of the compressor 34. This takes place in the case of the exemplary embodiment according to FIG. 3 again in mirror-image to the vertical central plane of the star feeder housing 78.

With the development of the star feeder metering unit 44 according to FIG. 3 the powder particles are prevented from lastingly settling on the star feeder and/or on the star feeder housing without allowing the powder particles to escape from the cells 94.

With the development of the star feeder metering unit 44 shown in FIG. 3 the entire conveyance distance of the powder from the outlet storage vessel 38 up to the outlet of the star feeder metering unit 44 is free from angles and edges, on which powder particles could accumulate or settle.

Thus the delivery of powder particles to the conditioning vessel 46 is uniform and to a large extent homogeneous.

For even better homogenization of the powder delivery to the conditioning vessel 46, the star feeder housing 78 can be provided with a cylindrical peripheral surface, mounted rotatably in a cylindrical bush around the housing axis as illustrated in FIG. 3 with a broken line.

There a bearing bush is marked as 170, which surrounds the star feeder housing 78 with sliding play and supports an upper base plate 172, which engages the upper front face of the star feeder housing 78. A central orifice 174 of the base plate 172 produces a smooth and concise connection between the inlet 84 and the conical inner face 166 of the lower end of the storage vessel 38.

A lower base plate 176 has a central orifice 178, which is at a radially outward distance from the outlet 86 of the star feeder housing 78. The base plates 172 and 176 are connected by bolts, not shown, to the bearing bush 170.

Inside the orifice 178 the lower front surface star feeder housing 78 supports a toothed rim 180, on which a gear wheel 182 runs, that is rotatable around a horizontal axis and driven by an electric motor 184. This is driven alternately in the forwards direction and/or backwards direction by a gate circuit 186 around a pre-defined angle (in the case of the exemplary embodiment by a few revolutions, so that the star feeder housing rotates by integral multiples of 180°), whereby the distance covered in the particular direction is proportional to the output signal of an angle sensor 188, which is coupled with the shaft of the electric motor 184.

Thus the distribution of the powder curtain delivered in the metering vessel 46 is uniform not only in the radial direction but also in the circumferential direction.

The various air-permeable materials, which are impinged from the back by positive pressure, preferably concern sinter materials, which in turn preferably consist of a plastic material. In cases, where electrostatic charges have to be avoided, the porous wall material however can also consist of a sintered metal such as sintered bronze and can be electrically connected to earth.

The pore size of the sinter material is selected in such a way that it is smaller than the diameter of the powder particles so that even if these materials are not impinged from the back by pressure, powder particles at worst settle loosely and only partly into the pores of the sinter material.

For the vessels, connecting lines and other throughput sections of the powder source 10 stainless steel is the preferred material.

The control pressures for the various pressure control valves are selected so that the desired fluidization and the desired ratio between fluidization gas and powder are obtained. Typically a pressure is maintained inside the conditioning vessel 46, which is approximately 0.25 greater than the pressure in the remaining sections of the powder source 10.

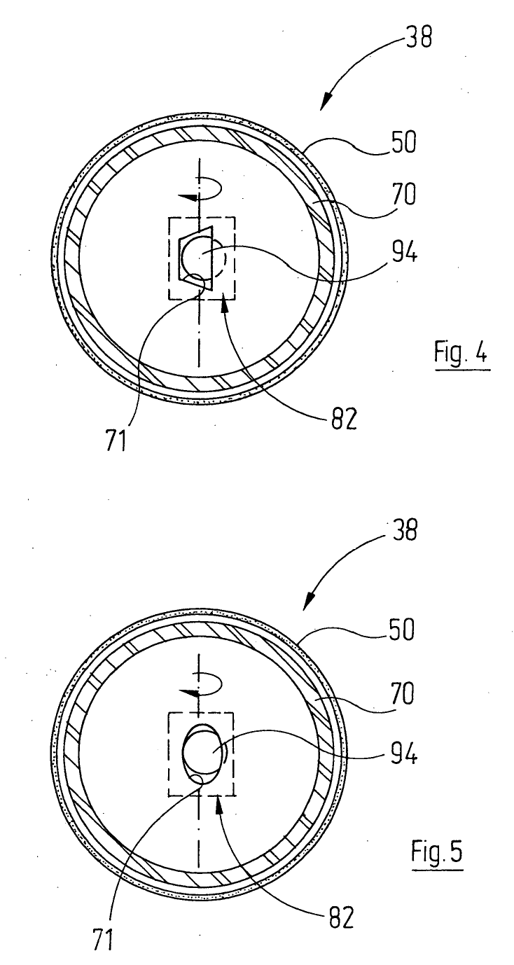

In the case of the variants shown in FIGS. 4 to 8 and described below components, which function similarly to components already described above, are again provided with the same reference symbols. They are not described again below, apart from any differences.

FIGS. 4 and 5 show views onto the lower end of modified storage vessels 38, wherein the outlet 71 is not rotationally symmetric. Furthermore the star feeder 82 lying underneath is indicated with one of its dome shaped cells.

According to FIG. 4 the outlet 94 has the form of a trapezoid, whereby trapezoidal sides parallel to one another run parallel to the rotational axis of the star feeder 82. The longer trapezoidal side lies in such a way that it is first met by an approaching cell 94.

According to FIG. 5 the outlet 71 is oval, whereby the long axis of the ellipse runs parallel to the star feeder axis.

In both cases the long axis of the outlet 71 is greater than the diameter of the cells 94 and the outlet 71 is symmetrical to the line of the cell midpoints.

If the outlet 71 is circular its diameter is likewise greater than the diameter of the cells 94.

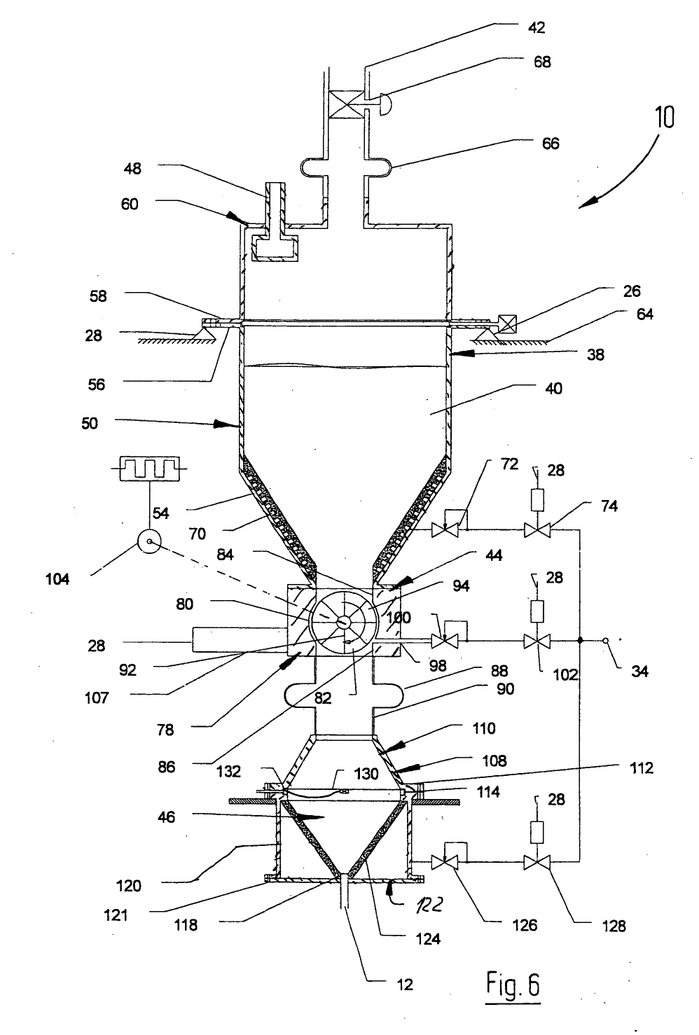

The powder source 10 according to FIG. 6 differs from that in FIG. 2 by the structure of the conditioning vessel 46.

The porous base section 124 is conical and the discharge line 12 receiving the fluidized metered powder emerges from its underlying tip.

The cylindrical annular section 120 having a greater axial dimension surrounds the base section 124 and at the lower end is closed by the now disk-shaped cover 122, through which the discharge line 12 is led with a tight seal.

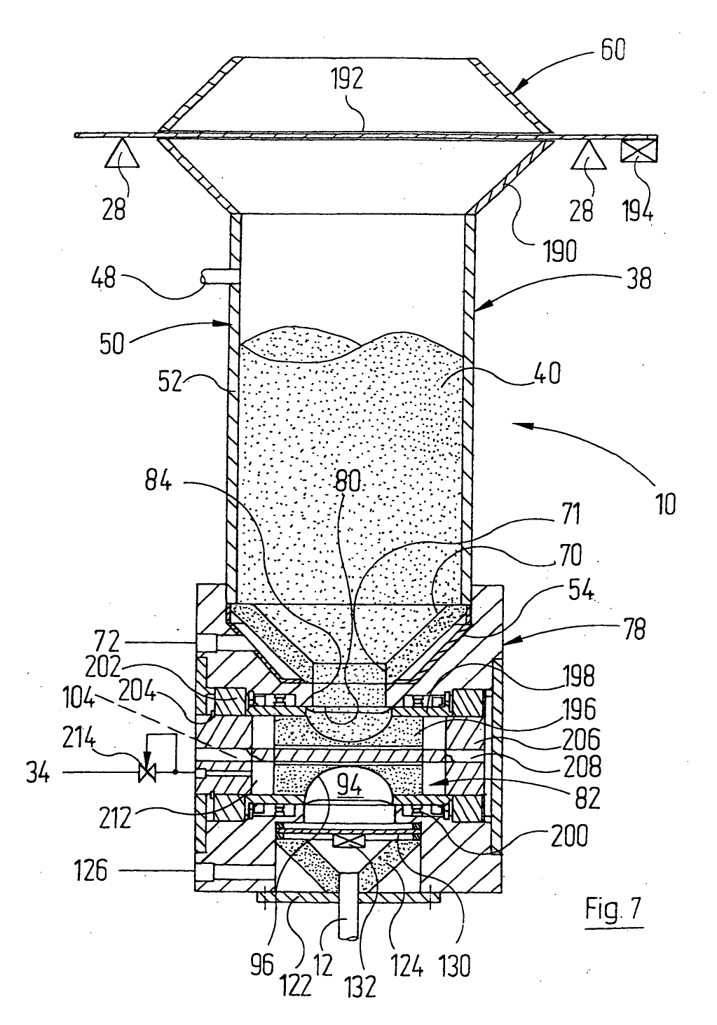

With the powder source 10 according to FIG. 7 a filter 192, against which the storage vessel 38 is supported on the weighing cells 28, is firmly clamped between the now truncated cover 60 and a reverse truncated upper end section 190. The filter 192 is vibrated by a vibrator or a breaker 194 at high frequency, which in practice is about 10 kHz to about 60 kHz. In this way agglomerates and clumps are already broken up when the storage vessel 38 is filled.

The star feeder 82 now has a wheel body 196, which is entirely made from an open-pored sinter material, as already discussed further above. The wheel body 198 in its peripheral face is constituted by the dome shaped cells 94. It is firmly supported on both sides by end sleeves 198, which run in bearings 200. Axial-thrust bearing rings 202 position the star feeder 82 in the axial direction. They are in turn supported by circlips 204 on bearing blocks 206.

A shaft 206 extends with rotational fit through the wheel body 196. This is provided in its middle section with an axial groove 210, so that a flow medium path is obtained between the two front faces of the wheel body 190 and towards the inner face of the wheel body 196.

As evident from FIG. 7, the bearing blocks 206 are at a distance from the front faces of the wheel body 196 and one of the chambers 212 obtained in this way is connected via a pressure control valve 214 to the output of the pressure control valve 34. Like the other pressure control valves downstream of the pressure control valve 34, this serves to provide a pressure which is locally particularly suitable.

It is clear that the boundary walls of the cells 94 can be impinged by fluidization air, which prevents powder particles lastingly clinging on.

With the embodiment according to FIG. 7 a lower section of the housing 78 at the same time serves to accommodate the base section 124, an upper part of the housing 78 serving to accommodate the lower end of the storage vessel 38. The entire powder source thus has a very compact structure.

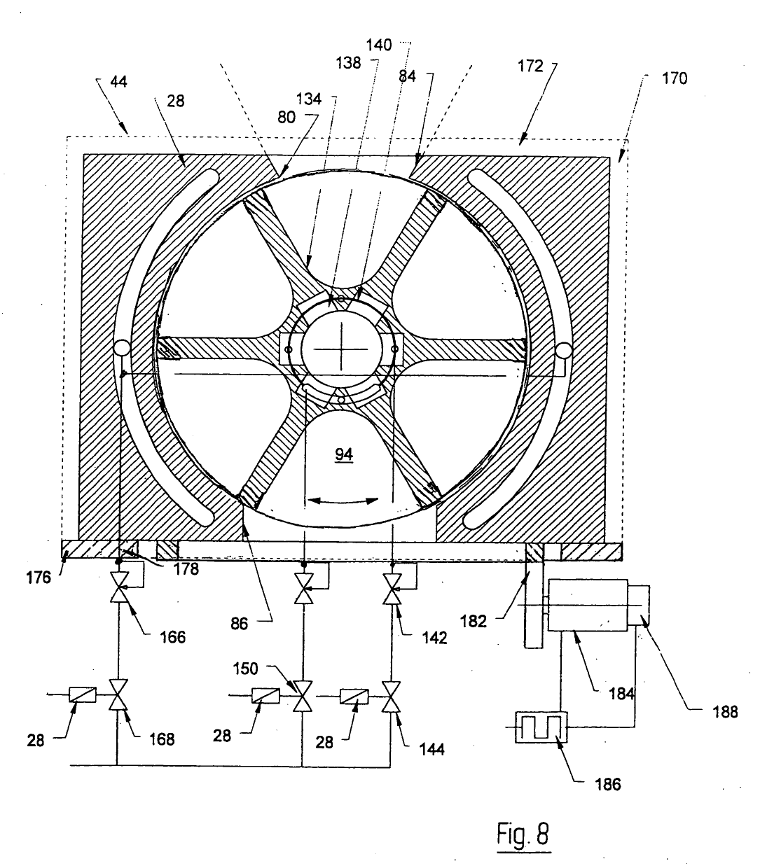

With the embodiment of the metering unit 44 according to FIG. 8 the star feeder 82 and the housing 78 are both made from an open-pored sinter material, which however has already been discussed above in various ways. Therefore the mechanical structure is simpler than in the case of the embodiment according to FIG. 3; the function in the end is the same: powder particles cannot lastingly cling either on the star feeder 82 or on the housing 78, since they are lifted and moved away by the air flowing from the surfaces.

1. Powder source for a powder coating plant comprising:
a) a storage vessel for powder;
b) a conditioning vessel, which exhibits a first inlet for powder, a second inlet for fluidization gas and an outlet for a fluid powder/gas mixture and
c) a metering unit arranged between an outlet of the storage vessel and the inlet of the conditioning vessel, which exhibits a star feeder and a star feeder housing, having an accommodation area for the star feeder a as well as a powder inlet and a powder outlet, which communicates with the accommodation area.

2. Powder source according to claim 1, wherein cells of the star feeder have edge-free boundary walls.

3. Powder source according to claim 2, wherein at least one base section of the cells is partly cylindrical or partly spherical.

4. Powder source according to claim 2, wherein the boundary walls of the cells in one position of the star feeder gradually change into the inlet of the star feeder housing.

5. Powder source according to claim 1, wherein the boundary walls of the cells are at least partly air-permeable and are impinged by compressed gas on their side turned away from the star feeder housing.

6. Powder source according to claim 5, wherein the boundary walls of the cells are formed at least partly by at minimum one sinter material.

7. Powder source according to claim 6, wherein the sinter materials are plastic sinter materials or electrically conductive sinter materials, in particular, sintered metal materials.

8. Powder source according to claim 5, wherein the air-permeable sections of the boundary walls are impinged by the compressed gas as a function of the angular position of the star feeder or as a function of the position to the housing.

9. Powder source according to claim 8, wherein the back of the air-permeable sections of the boundary walls of the cells are impinged via housing-fixed supply grooves, which overlap supply ducts constituted by the rim in the star feeder.

10. Powder source according to claim 9, wherein the backs of the air-permeable sections of the boundary walls of the cells are impinged via at least two control grooves, one of which exhibits an angular extension wherein the supply ducts of the star feeder overlap with the supply groove, whenever the star feeder is adjacent to the outlet of the star feeder housing.

11. Powder source according to claim 1, wherein at least one section of the boundary of the accommodation area for the star feeder is at least partly gas-permeable and on their back is impinged by compressed gas.

12. Powder source according to claim 11, wherein the air-permeable section of the boundary wall of the accommodation area with its end adjacent to the powder inlet is at a distance from the powder inlet.

13. Powder source according to claim 1, wherein the star feeder is driven alternately in the opposite direction.

14. Powder source according to claim 1, wherein the star feeder housing is rotatable around the axis of its outlet.

15. Powder source according to claim 1, wherein the open cross-section area at the lower end of the storage vessel is smaller than the cross-section area of the outer region of the star feeder accommodation area.

16. Powder source according to claim 1, wherein a trapezoidal orifice is provided on the lower side of the storage vessel, whereby the longer of the parallel base sides first brushes over the outer edge of the respective cell of the star feeder in the main direction of rotation.

17. Powder source according to claim 1, wherein the powder outlet of the powder storage vessel is round or oval.

18. Powder source according to claim 1, wherein the cross-section area on the upper side of the conditioning vessel is equal or slightly larger than the outer cross-section area of the accommodation area for the star feeder.

19. Powder source according to claim 14, wherein the star feeder housing is rotated alternately around angles of 180° or integrally in multiples of 180° in the opposite direction of rotation around the axis of the outlet.

20. Powder source according to claim 1, wherein the star feeder is coupled directly or via the star feeder housing with a vibration exciter, which preferably works at a frequency of 10 to 120 Hz.

21. Powder source according to claim 1, wherein a lower section of the storage vessel is provided at least partly with a gas-permeable wall, whose back is connected to a source of compressed gas.

22. Powder source according to claim 1, wherein the storage vessel is provided with a ventilation system, which preferably is arranged in its upper section.

23. Powder source according to claim 22, wherein a filter is provided in front of the ventilation system, which retains powder particles.

24. Powder source according to claim 1, wherein the storage vessel is supported via weighing equipment on a static frame section.

25. Powder source according to claim 1, wherein the star feeder housing exhibits a compressed gas duct, which in the vicinity of the outlet of the star feeder housing opens into the accommodation area.

26. Powder source according to claim 1, wherein the star feeder housing is connected via a compensator to the conditioning vessel.

27. Powder source according to claim 1, wherein a filter running substantially perpendicularly to the vessel axis is arranged in an upper section of the conditioning vessel.

28. Powder source according to claim 27, wherein the filter is a mesh filter, whose mesh size is about 2.5 to about 5 times the average diameter of the powder particles.

29. Powder source according to claim 27, wherein a vibrator is coupled onto the filter, which preferably works at a frequency of about 10 kHz to about 60 kHz.

30. Powder source according to claim 1, wherein a base of the conditioning vessel is gas-permeable and on its back can be connected to a source of compressed gas.

31. Powder source according to claim 30, wherein a lower end section of the conditioning vessel lying over the base or the base itself is conical or cylindrical.

32. Powder source according to claim 30, wherein an outlet for the mixture of powder and fluidization gas is provided in a lower end section of the conditioning vessel, preferably emerging from a radially central region of the same.

33. Powder source according to claim 32, wherein the outlet is at about ⅔ the overall height of the cylindrical end section.

34. Powder source according to claim 33, wherein the distance, measured in the axial direction between the outlet and the base of the conditioning vessel is about ⅛ to about ¼, preferably about ⅙ that distance, which lies between the filter and the base of the conditioning vessel.

35. Powder source according to claim 1, wherein an acceleration unit, which accelerates the mixture of powder and fluidization gas is provided behind the mixture outlet.

36. Powder source according to claim 35, wherein the acceleration unit works according to the water jet principle and has an acceleration gas inlet connected to a source of acceleration gas and a mixture inlet connected to the mixture outlet of the conditioning vessel.
